(19) United States
(12) Patent Application Publication
(10) Pub. No.: US 2020/0198460 A1
(43) Pub. Date: Jun. 25, 2020

(54) FUEL SUPPLY APPARATUS FOR INTERNAL COMBUSTION ENGINE

(71) Applicant: AISAN KOGYO KABUSHIKI KAISHA, Obu-shi (JP)

(72) Inventors: Yoshihiko HONDA, Obu-shi (JP); Yuya TANIDA, Obu-shi (JP); Satomi YOKOI, Nagoya-shi (JP)

(73) Assignee: AISAN KOGYO KABUSHIKI KAISHA, Obu-shi (JP)

(21) Appl. No.: 16/710,082

(22) Filed: Dec. 11, 2019

(30) Foreign Application Priority Data
Dec. 20, 2018 (JP) 2018-238521

(51) Int. Cl. B60K 15/035; F02M 31/20; F02M 25/08; F02M 37/00; B01D 53/04

(52) U.S. Cl. CPC B60K 15/03504; F02M 31/20; F02M 25/089; B60K 2015/03243; F02M 25/0854; B01D 53/0438; F02M 37/0052

(57) ABSTRACT

A fuel supply system for supplying a fuel from a fuel tank to an engine includes a fuel pump for delivering a fuel from the fuel tank, a fuel pipe for flowing therethrough the fuel from fuel pump, a canister including an activated carbon capable of adsorbing and desorbing vaporized fuel generated in the fuel tank, a heat exchanging mechanism for performing heat exchange between the fuel pipe and the canister on a downstream side of the fuel pump, and a return pipe for returning the fuel from the fuel pipe to the fuel tank on a downstream side of the heat exchanging mechanism.

### CROSS-REFERENCE TO RELATED APPLICATIONS

This application is based upon and claims the benefit of priority from the prior Japanese Patent Application No. 2018-238521 filed on Dec. 20, 2018, the entire contents of which are incorporated herein by reference.

### BACKGROUND

### Technical Field

The present disclosure relates to a fuel supply apparatus for an internal combustion engine for supplying fuel to an internal combustion engine.

### Related Art

As a conventional art, Japanese unexamined patent application publication No. 2003-262163 (“JP 2003-262163A”) discloses a cooling device for engine supply fuel to cool the fuel to be supplied to an engine. This device is configured to cool the fuel by use of an air-conditioning cooling fan placed in a fuel pipe through which the fuel is supplied from a fuel tank to the engine.

### SUMMARY

### Technical Problems

However, the device disclosed in JP 2003-262163A is provided with a dedicated cooling mechanism, such as an air-conditioning cooling fan, in order to cool the fuel. This configuration results in an increase in apparatus size.

The present disclosure has been made to address the above problems and has a purpose to provide a fuel supply apparatus for an internal combustion engine and configured to cool fuel while achieving reduction in apparatus size.

### Means of Solving the Problems

To achieve the above-mentioned purpose, one aspect of the present disclosure provides a fuel supply apparatus for an internal combustion engine, the apparatus being configured to supply a fuel from a fuel tank that stores the fuel to the internal combustion engine, and the apparatus comprising: a fuel pump configured to deliver the fuel from the fuel tank; a fuel pipe through which the fuel delivered by the fuel pump flows; a canister provided with an adsorbent capable of adsorbing and desorbing vaporized fuel generated in the fuel tank; a heat exchanging mechanism configured to perform heat exchange between the fuel pipe and the canister on a downstream side of the fuel pump; and a return pipe configured to allow the fuel to return from the fuel pipe on a downstream side of the heat exchanging mechanism to the fuel tank.

According to the above configuration, the heat exchanging mechanism allows heat exchange between the fuel pipe and the canister, thereby cooling the fuel flowing through the fuel pipe. Since the fuel flowing through the fuel pipe can be thus cooled by the canister, a separate special cooling mechanism to cool the fuel flowing through the fuel pipe is not required. This fuel supply apparatus for an internal combustion engine configured as above can cool the fuel while achieving reduction in apparatus size.

Since the fuel is cooled by the heat exchanging mechanism, it is possible to decrease the pressure to be applied to the fuel flowing through the fuel pipe to reduce evaporation of the fuel in the fuel pipe, that is, to prevent vapor lock. This configuration can reduce a difference between the pressure of the fuel returned to the fuel tank and the internal pressure of the fuel tank when the fuel returns from the fuel pipe to the fuel tank via the return pipe, so that the fuel is less likely to vaporize. Thus, the fuel supply apparatus can reduce the amount of vaporized fuel to be generated in the fuel tank and hence the canister can be designed with a small capacity to adsorb and store the vaporized fuel generated in the fuel tank.

The fuel supply apparatus for an internal combustion engine according to the present disclosure can cool fuel while achieving reduction in apparatus size.

### BRIEF DESCRIPTION OF THE DRAWINGS

FIG. 1 is a schematic diagram of a fuel supply system in a first embodiment;

FIG. 2 is a schematic diagram of a modified example of the fuel supply system in the first embodiment; and

FIG. 3 is a schematic diagram of a fuel supply system in a second embodiment.

### DETAILED DESCRIPTION OF THE EXEMPLARY EMBODIMENTS

A detailed description of embodiments of a fuel supply apparatus for an internal combustion engine, typically embodying this disclosure, will now be given referring to the accompanying drawings.

### First Embodiment

A fuel supply system 1 in the first embodiment will be described below.

### (Outline of the Fuel Supply System)

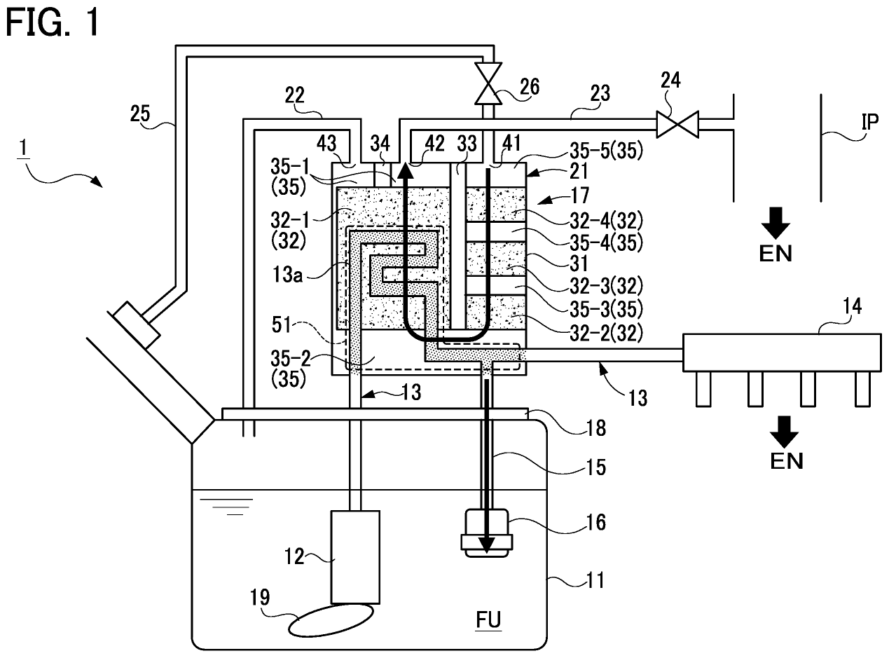

The fuel supply system 1 includes, as shown in FIG. 1, a fuel tank 11, a fuel pump 12, a fuel pipe 13, a delivery pipe 14, a return pipe 15, a pressure regulator 16, a vaporized fuel treating apparatus 17, and a flange 18.

The fuel tank 11 is a container for storing a fuel as indicated by FU in FIG. 1. The fuel pump 12 is a device for feeing the fuel from the fuel tank 11 to the fuel pipe 13. A suction port of the fuel pump 12 is provided with a suction filter 19 for filtering the fuel.

The fuel pipe 13 is connected, at its one end, to the fuel pump 12 and, at its other end, to the delivery pipe 14 to allow the fuel pumped by the fuel pump 12 to flow toward the delivery pipe 14. This fuel pipe 13 is provided with a heat exchanging section 13a configured to exchange heat with a canister 21 mentioned later. The heat exchanging section 13a constitutes a heat exchanging mechanism 51 mentioned later and is placed in the canister 21, i.e., in a canister case 31 mentioned later. The fuel pipe 13 is attached to the flange 18 so as to extend therethrough into the tank 11.

The delivery pipe 14 is configured to distribute the fuel supplied from the fuel tank 11 to a plurality of injectors (not shown), that is, a fuel injection valve for supplying fuel to an engine EN (see FIG. 1).

The return pipe 15 is a pipe branching off from the fuel pipe 13 and allowing the fuel to return from the fuel pipe 13 on a downstream side in a fuel flowing direction in the heat exchanging section 13a (i.e., the heat exchanging mechanism 51 mentioned later) of the fuel pipe 13 to the tank 11. The return pipe 15 is attached to the flange 18 so as to extend therethrough into the tank 11.

The pressure regulator 16 is placed in the return pipe 15 and configured to regulate the pressure of fuel to be returned to the fuel tank 11 via the return pipe 15. This pressure regulator 16 is for example a pressure regulator of the present disclosure.

The vaporized fuel treating apparatus 17 is configured to perform treatment for supply of the vaporized fuel (vapor) generated in the fuel tank 11 to the engine EN. The details of the vaporized fuel treating apparatus 17 will be described later.

In the fuel supply system 1 configured as above, the fuel stored in the fuel tank 11 is pumped by the fuel pump 12 to flow into the fuel pipe 13 and supplied to the engine EN through the delivery pipe 14. In the fuel supply system 1, furthermore, the excess fuel of the fuel flowing through the fuel pipe 13 to the fuel tank 11 is returned from the fuel pipe 13 through the return pipe 15 and the pressure regulator 16. As described above, the fuel supply system 1 thus supplies the fuel from the fuel tank 11 to the engine EN while returning the excess fuel to the fuel tank 11.

### (Vaporized Fuel Treating Apparatus)

The vaporized fuel treating apparatus 17 will be described below. This vaporized fuel treating apparatus 17 includes a canister 21, a vapor passage 22, a purge passage 23, a purge valve 24, an atmosphere passage 25, and a tank closing valve 26.

The canister 21 is provided with a canister case 31 and activated carbon 32.

The canister case 31 accommodates therein the activated carbon 32 so that the vaporized fuel flowing therein from the fuel tank 11 via the vapor passage 22 adsorb onto the activated carbon 32. This canister case 31 is provided with an atmosphere port 41, a purge port 42, and a tank port 43.

The atmosphere port 41 is an intake port through which purge air (atmospheric air) is introduced into the canister 21 from atmospheric space (simply, “atmosphere”) through the atmosphere passage 25. The purge port 42 is an outflow port through which purge gas, which is the gas containing the purge air and the vaporized fuel, flows out of the canister case 31 to the outside the canister case 31. The tank port 43 is an inflow port through which the vaporized fuel flows from the fuel tank 11 into the canister case 31 via the vapor passage 22.

The inside of the canister case 31 is partitioned by a first partition part 33 and a second partition part 34.

The activated carbon 32 is an adsorbent capable of adsorbing and desorbing vaporized fuel generated in the fuel tank 11 and is placed in the canister case 31. Herein, as one example, the activated carbon 32 is provided in four places in the canister case 31. Specifically, the activated carbon 32 in the four places forms four layers arranged from a position near the purge port 42 toward the atmosphere port 41 in the order of a first layer of activated carbon (“first-layer activated carbon”) 32-1 (a first adsorbent), a second layer of activated carbon (“second-layer activated carbon”) 32-2 (a second adsorbent), a third layer of activated carbon (“third-layer activated carbon”) 32-3 (a third adsorbent), and a fourth layer of activated carbon (“fourth-layer activated carbon”) 32-4 (a fourth adsorbent).

Furthermore, in the canister case 31, there are provided five chambers 35; namely, a first chamber 35-1, a second chamber 35-2, a third chamber 35-3, a fourth chamber 35-4, and a fifth chamber 35-5.

The first chamber 35-1 is located between the purge port 42 and the tank port 43 and the first-layer activated carbon 32-1. The second chamber 35-2 is located between the first-layer activated carbon 32-1 and the second-layer activated carbon 32-2. The third chamber 35-3 is located between the second-layer activated carbon 32-2 and the third-layer activated carbon 32-3. The fourth chamber 35-4 is located between the third-layer activated carbon 32-3 and the fourth-layer activated carbon 32-4. The fifth chamber 35-5 is located between the fourth-layer activated carbon 32-4 and the atmosphere port 41.

In the present embodiment shown in FIG. 1, the first-layer activated carbon 32-1 is placed in one of the regions partitioned by the first partition part 33 in the canister case 31, that is, in a left region in FIG. 1. In the canister case 31, furthermore, the second-layer activated carbon 32-2, the third-layer activated carbon 32-3, and the fourth-layer activated carbon 32-4 are placed in the other of the regions partitioned by the first partition part 33, that is, in a right region in FIG. 1.

In the present embodiment shown in FIG. 1, moreover, the first chamber 35-1 is partitioned by the second partition part 34 into two regions, one of which, i.e., a left region in FIG. 1, communicates with the tank port 43 and the other of which, i.e., a right region in FIG. 1, communicates with the purge port 42.

The vapor passage 22 is connected at its one end to the fuel tank 11 and at its other end to the tank port 43 of the canister case 31. The purge passage 23 is connected at its one end to the purge port 42 of the canister case 31 and at its other end to an intake pipe IP connected to the engine EN. The purge valve 24 is provided in the purge passage 23 and configured to open and close the purge passage 23. The atmosphere passage 25 has one end connected to the atmosphere and the other end connected to the atmosphere port 41 of the canister case 31. The tank closing valve 26 is provided in the atmosphere passage 25 and configured to open and close the atmosphere passage 25.

In the vaporized fuel treating apparatus 17 configured as above, the vaporized fuel flowing from the fuel tank 11 to the canister case 31 of the canister 21 through the vapor passage 22 and the tank port 43 adsorbs onto the activated carbon 32 and is stored in the canister case 31. When a purge condition is established during operation of the engine EN, the vaporized fuel treating apparatus 17 performs a purge control for treatment to supply the purge gas containing the vaporized fuel from the canister 21 to the engine EN.

In this purge control, in the present embodiment, the purge air firstly flows from the atmosphere into the fifth chamber 35-5 through the atmosphere passage 25 and the atmosphere port 41. Successively, as indicated by an arrow in FIG. 1, The purge air flowing in the fifth chamber 35-5 further flows in the fourth-layer activated carbon 32-4, thereby causing the vaporized fuel having adsorbed on the fourth-layer activated carbon 32-4 to desorb therefrom. During this desorption of the vaporized fuel from the fourth-layer activated carbon 32-4, the purge gas becomes cooled.

Subsequently, the purge gas containing the vaporized fuel desorbed from the fourth-layer activated carbon 32-4 and the purge air will pass through the fourth chamber 35-4, the third-layer activated carbon 32-3, the third chamber 35-3, the second-layer activated carbon 32-2, the second chamber 35-2, the first-layer activated carbon 32-1, and the first chamber 35-1 in sequence. Accordingly, the vaporized fuel having adsorbed on the activated carbon 32 (activated carbon particles) in each of the third-layer activated carbon 32-3, the second-layer activated carbon 32-2, and the first-layer activated carbon 32-1 desorbs therefrom. During this desorption of the vaporized fuel from each activated carbon 32, the purge gas becomes cooled. Then, the purge gas flows in the intake pipe IP through the purge port 42, the purge passage 23, and the purge valve 24 in a valve-open state, and is supplied for treatment in the engine EN.

### (Heat Exchanging Mechanism)

In the present embodiment, during execution of the purge control, the purge gas is cooled by desorption of the vaporized fuel having adsorbed on each activated carbon 32, thereby cooling the fuel flowing through the fuel pipe 13. In the fuel supply system 1, therefore, the fuel pipe 13 is placed in the canister case 31 of the canister 21 located on a downstream side in a fuel flowing direction, that is, at a position closer to the engine EN, relative to the fuel pump 12. The fuel supply system 1 further includes the heat exchanging mechanism 51 configured to perform heat exchange between the fuel pipe 13 and the canister 21. Specifically, this heat exchanging mechanism 51 is configured to perform heat exchange between the heat exchanging section 13a forming a part of the fuel pipe 13 and the first-layer activated carbon 32-1 and the second chamber 35-2 in the canister 21. Herein, during execution of the purge control, the purge gas cooled by desorption of the vaporized fuel having adsorbed on each activated carbon 32 further cools the fuel flowing through the heat exchanging section 13a of the fuel pipe 13.

In the present embodiment shown in FIG. 1, the heat exchanging section 13a of the fuel pipe 13 is defined by a part of the fuel pipe 13, arranged in the first-layer activated carbon 32-1 in the canister 21 and another part of the fuel pipe 13 located in the second chamber 35-2 in the canister 21, these parts being indicated with dot hatching in FIG. 1.

The heat exchanging mechanism 51 is placed near the purge port 42, as shown in FIG. 1. Specifically, the heat exchanging section 13a of the fuel pipe 13, constituting the heat exchanging mechanism 51, is partly provided in the first-layer activated carbon 32-1 located near the first chamber 35-1 which is the space directly underneath the purge port 42. Accordingly, the fuel flowing through the heat exchanging section 13a of the fuel pipe 13 is efficiently cooled by the purge gas cooled by desorption of the vaporized fuel through the fourth-layer activated carbon 32-4, the third-layer activated carbon 32-3, and the second-layer activated carbon 32-3.

The heat exchanging section 13a of the fuel pipe 13 is not provided near the tank port 43. Therefore, the vaporized fuel flowing from the fuel tank 11 into the canister case 31 through the vapor passage 22 and the tank port 43 is less likely to adhere to the heat exchanging section 13a of the fuel pipe 13. Thus, heat is less generated due to adhesion of the vaporized fuel in the heat exchanging section 13a of the fuel pipe 13.

In the fuel supply system 1 including the heat exchanging mechanism 51 as above, when the fuel pumped up by the fuel pump 12 from the fuel tank 11 and increased in pressure flows through the fuel pipe 13 during execution of the purge control during operation of the engine EN, this fuel is cooled by the purge gas cooled by desorption of the vaporized fuel in the activated carbon 32. Accordingly, during operation of the engine EN in which the fuel pump 12 is driven to flow the fuel to the fuel pipe 13, the fuel can be cooled through the heat exchanging mechanism 51. Since the fuel pump 12 is not driven uneconomically only for the purse of cooling the fuel, the power consumption can be reduced.

The fuel cooled in the above manner is supplied to the engine EN via the delivery pipe 14. In contrast, excess fuel, which is a part of the cooled fuel, is returned to the fuel tank 11 through the return pipe 15 and the pressure regulator 16. Thus, the fuel in the fuel tank 11 is cooled. Accordingly, the fuel cooled in the fuel pipe 13 located upstream of the return pipe 15 is returned into the fuel tank 11 while the fuel is less exposed to the heat from the engine EN. This can prevent a rise in temperature of the fuel in the fuel tank 11 and hence suppress the generation of vaporized fuel. Since the generation of vaporized fuel is suppressed in the fuel tank 11, the canister case 31 can be designed with a small capacity for storing the vaporized fuel adsorbing onto the activated carbon 32. Further, inexpensive activated carbon 32 having not so high adsorbability to vaporized fuel can be used and hence cost reduction can be obtained.

Since the fuel cooled in the heat exchanging mechanism 51 flows through the fuel pipe 13 toward the engine EN, the temperature rise of the fuel due to exposure to the heat from the engine EN is prevented. It is accordingly possible to set low the pressure to be applied to the fuel flowing through the fuel pipe 13, e.g., by use of the pressure regulator 16, in order to prevent the fuel from vaporizing in the fuel pipe 13, that is, prevent vapor lock. When the fuel is returned from the fuel pipe 13 to the fuel tank 11 through the return pipe 15, therefore, a difference between the pressure of the fuel returned to the fuel tank 11 and the internal pressure of the fuel tank 11 can be reduced. Thus, vaporization of the fuel due to decompression boiling less occurs. Consequently, the amount of vaporized fuel to be generated in the fuel tank 11 is reduced and thus the canister case 31 can be designed with a reduced capacity to adsorb and store vaporized fuel generated in the fuel tank 11.

### Modified Example

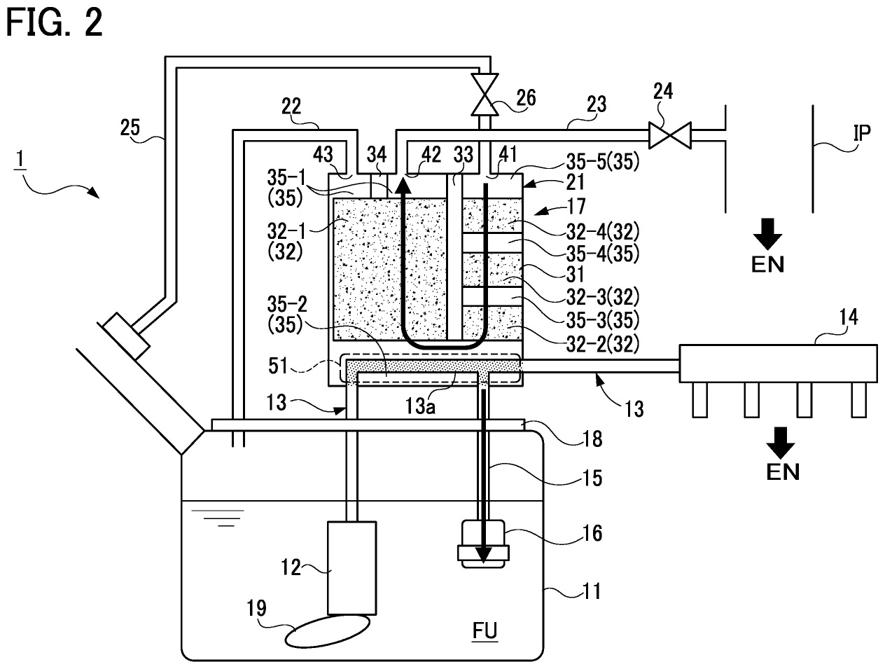

A modified example is shown in FIG. 2, in which the heat exchanging mechanism 51 (the heat exchanging section 13a of the fuel pipe 13) may be provided only in the second chamber 35-2. Accordingly, the fuel flowing through the fuel pipe 13 is cooled in the heat exchanging section 13a by the cooled purge gas flowing through the second chamber 35-2.

### (Operations and Effects of the First Embodiment)

The fuel supply system in the first embodiment, as described above, includes the heat exchanging mechanism 51 on the downstream side of the fuel pump 12 to perform heat exchange between the fuel pipe 13 and the canister 21. The fuel supply system 1 includes the return pipe 15 on the downstream side of the heat exchanging mechanism 51 to return the fuel to the fuel tank 11.

In the heat exchanging mechanism 51, accordingly, heat exchange between the fuel pipe 13 and the canister 21 can cool the fuel flowing through the fuel pipe 13. Specifically, during execution of the purge control, the fuel flowing through the heat exchanging section 13a of the fuel pipe 13 is cooled by the purge gas cooled by desorption of the vaporized fuel from the activated carbon 32 in the heat exchanging mechanism 51. Since the fuel flowing through the fuel pipe 13 is cooled as above, any special cooling mechanism to cool the fuel flowing through the fuel pipe 13 can be dispensed with. The fuel supply system 1 is configured to cool the fuel flowing through the fuel pipe 13 while achieving reduction in apparatus size.

Since the fuel is cooled by the heat exchanging mechanism 51, furthermore, it is possible to set low the pressure to be applied to the fuel flowing through the fuel pipe 13 to prevent the fuel from vaporizing in the fuel pipe 13. When the fuel (excess fuel) is returned from the fuel pipe 13 to the fuel tank 11 through the return pipe 15, a difference between the pressure of the fuel returned to the fuel tank 11 and the internal pressure of the fuel tank 11 can be reduced, so that the fuel less vaporizes. Consequently, the amount of vaporized fuel to be generated in the fuel tank 11 can be reduced and thus the canister case 31 can be designed with a reduced capacity to adsorb and store vaporized fuel generated in the fuel tank 11.

Moreover, the heat exchanging mechanism 51 (the heat exchanging section 13a of the fuel pipe 13) is placed inside the canister case 31. Thus, the heat exchanging mechanism 51 is less likely to be influenced by the heat from the outside of the canister case 31. The heat exchanging mechanism 51 therefore can enhance the efficiency of heat exchange between the fuel pipe 13 and the canister 21.

In the example in FIG. 1, a part of the heat exchanging mechanism 51 (the heat exchanging section 13a of the fuel pipe 13) is placed in the first-layer activated carbon 32-1 located near the purge port 42. Specifically, the heat exchanging mechanism 51 is provided in the first-layer activated carbon 32-1 located near the purge port 42 at which the temperature of the purge gas is most decreased during execution of the purge control for discharging the purge gas through the purge port 42. Accordingly, the heat exchanging mechanism 51 can enhance the efficiency of heat exchange between the fuel pipe 13 and the canister 21 during execution of the purge control.

The fuel supply system 1 includes the pressure regulator 16 provided in the return pipe 15 and configured to regulate the pressure of the fuel to be returned from the fuel pipe 13 to the fuel tank 11. Accordingly, since the pressure regulator 16 operates to regulate the pressure of fuel (excess fuel) when the fuel flows from the fuel pipe 13 back to the fuel tank 11 through the return pipe 15. This pressure regulation reduces a difference between the pressure of the fuel returned to the fuel tank 11 and the internal pressure of the fuel tank 11, so that the fuel is less likely to vaporize.

### Second Embodiment

A fuel supply system 2 in a second embodiment will be described below with a focus on differences from the first embodiment. Similar or identical parts of the fuel supply system 2 to those of the fuel supply system 1 are assigned with the same reference signs as those in the first embodiment and their details are not elaborated upon here.

### (Outline of the Fuel Supply System)

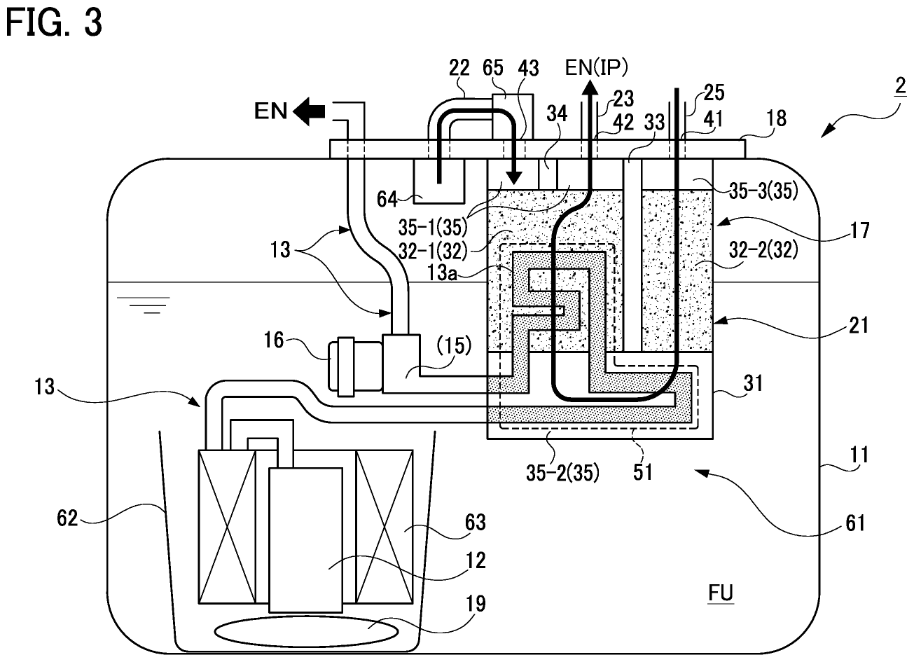

The fuel supply system 2 includes, as shown in FIG. 3, a pump module 61 integrally including the canister 21, the fuel pump 12, and a flange 18 for attachment to the fuel tank 11. A part of the pump module 61, including the canister 21 and the fuel pump 12, is placed in the fuel tank 11. As an alternative, the whole pump module 61 including the flange 18 may be placed in the fuel tank 11.

The fuel supply system 2 further includes a sub-tank 62, a high-pressure filter 63, a tank internal-pressure control valve 64, and a cutoff valve 65.

The sub-tank 62 is a container or a case that accommodates therein the fuel pump 12, the suction filter 19, and the high-pressure filter 63. The high-pressure filter 63 is a component for filtering fuel. In the present embodiment shown in FIG. 3, the high-pressure filter 63 has for example a cylindrical shape such that the fuel pump 12 is placed inside the inner periphery of the high-pressure filter 63. The tank internal-pressure control valve 64 is configured to control the internal pressure of the fuel tank 11. The cutoff valve 65 is configured to open and close the vapor passage 22.

Furthermore, as shown in FIG. 3, the activated carbon 32 is arranged as the first-layer activated carbon 32-1 and the second-layer activated carbon 32-2. As an alternative, this second-layer activated carbon 32-2 may be divided into two or more layers. The pressure regulator 16 is provided integral with the fuel pipe 13. The section of the fuel pipe 13, in which the pressure regulator 16 is integrally mounted, corresponds to the return pipe 15.

The fuel supply system 2 configured as above includes, as with the fuel supply system 1 in the first embodiment, the heat exchanging mechanism 51 placed in the canister case 31 of the canister 21 downstream of the fuel pump 12 and configured to perform heat exchange between the fuel pipe 13 and the canister 21.

### (Operations and Effects of the Second Embodiment)

The fuel supply system 2 in the second embodiment includes as described above the pump module 61 in which the canister 21, the fuel pump 12, and the flange 18 for installing the pump module 61 in the fuel tank 11 are integrated. At least a part of the pump module 61 is placed in the fuel tank 11.

Since the canister 21 is provided integral with the fuel pump 12 and others to constitute a part of the pump module 61 as described above, such a configuration can facilitate mounting of the fuel supply system 2 on a vehicle.

Moreover, the flange 18, the canister 21, and the fuel pump 12 are arranged in this order from an upper side to a lower side of the pump module 61 in the vertical direction of the fuel tank 11, i.e., in the vertical direction in FIG. 3. A part of the heat exchanging mechanism 51 (the heat exchanging section 13a of the fuel pipe 13) is placed in the second chamber 35-2 located on a lower side of the canister 21, i.e., on a side close to the fuel pump 12. In other words, the heat exchanging mechanism 51 is installed in a position near the lower surface of the canister case 31 of the canister 21 suspended from the flange 18.

Since the heat exchanging mechanism 51 is placed in the canister 21 at a position close to the fuel pump 12 as described above, the distance between the fuel pump 12 and the heat exchanging mechanism 51 can be short. Thus, the fuel pipe 13 extending from the fuel pump 12 to the heat exchanging mechanism 51 can be designed with a short length. The pump module 61 can therefore be provided in a reduced size.

The pressure regulator 16 is integrated with the canister case 31 and hence provided integrally with the pump module 61. Thus, the fuel pipe 13 can be designed with a short length and thus the pump module 61 can be provided in a compact size.

Furthermore, a part of the heat exchanging mechanism 51 (the heat exchanging section 13a of the fuel pipe 13) is placed in the first-layer activated carbon 32-1 located near the purge port 42. Specifically, the heat exchanging mechanism 51 is provided in the first-layer activated carbon 32-1 located near the purge port 42 at which the temperature of the purge gas is most decreased during execution of the purge control for discharging the purge gas through the purge port 42. Accordingly, the heat exchanging mechanism 51 can enhance the efficiency of heat exchange between the fuel pipe 13 and the canister 21 during execution of the purge control.

The foregoing embodiments are mere examples and give no limitation to the present disclosure. The present disclosure may be embodied in other specific forms without departing from the essential characteristics thereof.

For instance, the heat exchanging section 13a of the fuel pipe 13 constituting the heat exchanging mechanism 51 has only to be placed at any position within the canister case 31. For example, the heat exchanging section 13a of the fuel pipe 13 in the first embodiment has only to be placed in any position between the fifth chamber 35-5 located directly beneath the atmosphere port 41 and the first chamber 35-1 located directly beneath the purge port 42. The heat exchanging section 13a of the fuel pipe 13 in the fuel supply system 2 in the second embodiment has only to be placed in any position between the third chamber 35-3 directly beneath the atmosphere port 41 and the first chamber 35-1 directly beneath the purge port 42.

### REFERENCE SIGNS LIST

1 Fuel supply system
2 Fuel supply system
11 Fuel tank
12 Fuel pump
13 Fuel pipe
13a Heat exchanging section
15 Return pipe
16 Pressure regulator
17 Vaporized fuel treating apparatus
18 Flange
21 Canister
31 Canister case
32 Activated carbon
32-1 First-layer activated carbon
32-2 Second-layer activated carbon
32-3 Third-layer activated carbon
32-4 Fourth-layer activated carbon
35 Cavity
35-1 First chamber
35-2 Second chamber
35-3 Third chamber
35-4 Fourth chamber
35-5 Fifth chamber
42 Purge port
51 Heat exchanging mechanism
61 Pump module
EN Engine
IP Intake pipe

What is claimed is:

1. A fuel supply apparatus for an internal combustion engine, the apparatus being configured to supply a fuel from a fuel tank that stores the fuel to the internal combustion engine, and the apparatus comprising:
a fuel pump configured to deliver the fuel from the fuel tank;
a fuel pipe through which the fuel delivered by the fuel pump flows;
a canister provided with an adsorbent capable of adsorbing and desorbing vaporized fuel generated in the fuel tank;
a heat exchanging mechanism configured to perform heat exchange between the fuel pipe and the canister on a downstream side of the fuel pump; and
a return pipe configured to allow the fuel to return from the fuel pipe on a downstream side of the heat exchanging mechanism to the fuel tank.

2. The fuel supply apparatus for an internal combustion engine according to claim 1, wherein
the canister includes a canister case for accommodating the adsorbent, and
the heat exchanging mechanism is placed in the canister case.

3. The fuel supply apparatus for an internal combustion engine according to claim 2, wherein
the canister case includes a purge port through which a purge gas containing the vaporized fuel flows out of the canister, and
the heat exchanging mechanism is placed near the purge port.

4. The fuel supply apparatus for an internal combustion engine according to claim 1 further comprising a pressure regulator placed in the return pipe and configured to regulate pressure of the fuel to be returned from the fuel pipe to the fuel tank.

5. The fuel supply apparatus for an internal combustion engine according to claim 1 further comprising a pump module integrally including the canister, the fuel pump, and a flange for installing the pump module in the fuel tank,
wherein at least a part of the pump module is placed in the fuel tank.

6. The fuel supply apparatus for an internal combustion engine according to claim 5, wherein
the flange, the canister, and the fuel pump are arranged in this order in the pump module, and
the heat exchanging mechanism is placed in the canister at a position close to the fuel pump.

7. The fuel supply apparatus for an internal combustion engine according to claim 5 further comprising a pressure regulator placed in the return pipe and configured to regulate pressure of the fuel to be returned from the fuel pipe to the fuel tank,
wherein the pressure regulator is integral with the pump module.
